(19) United States
(12) Patent Application Publication
(10) Pub. No.: US 2013/0030702 A1
(43) Pub. Date: Jan. 31, 2013

(54) NAVIGATION SYSTEM

(71) Applicant: Takeshi Yamamoto, Tokyo (JP)

(72) Inventor: Takeshi Yamamoto, Tokyo (JP)

(73) Assignee: MITSUBISHI ELECTRIC CORPORATION, Tokyo (JP)

(21) Appl. No.: 13/642,090

(22) PCT Filed: Jul. 30, 2010
(86) PCT No.: PCT/JP2010/004841

§ 371 Date: Oct. 18, 2012

(51) Int. Cl. G01C 21/00

(52) U.S. Cl. 701/533

(57) ABSTRACT

A navigation system includes a data storage unit 9 for storing floor map information of a facility and a use pattern that records equipment to be used in the facility; a parking lot gate detection processing unit 11 for searching for, when a destination is set in the facility, the shortest route from the gateway of the facility to the destination among the routes leading to the destination via the equipment recorded in the use pattern according to the floor map information and use pattern; and a parking place information processing unit 12 for guiding a user along the route searched by the parking lot gate detection processing unit 11.

### TECHNICAL FIELD

The present invention relates to a navigation system for providing route guidance to a destination in a facility.

### BACKGROUND ART

Recently, because of an increase of the added value of a navigation terminal, various functions have been added. Among them, a function has been realized which guides a user to a parking lot with an open space by acquiring the congestion state of a parking lot around the vehicle or around the destination using VICS (Vehicle Information and Communication System: registered trademark, which is not mentioned from now on) information. In addition, to improve user's convenience, there is a technique of not only informing of a vacant state of a parking lot, but also finding and informing of an open space in the parking lot.

For example, Patent Document 1 discloses an apparatus for giving route guidance, considering convenience after getting off a vehicle by informing a user of a parking space suitable for entering a target facility by considering a distance from a vacant parking space in the lot to the in-store target facility.

### PRIOR ART DOCUMENT

### Patent Document

Patent Document 1: Japanese Patent Laid-Open No. 2005-4431.

### DISCLOSURE OF THE INVENTION

However, a conventional apparatus typified by the Patent Document 1 selects a route using as its decision reference only the distance from the parking place to the in-store target facility. Accordingly, even if the distance from the informed parking place to the in-store target facility is short, there are some cases where equipment in the store such as elevators, escalators and stairs, which has to be used to arrive at the target facility, is distant from the route. As a result, the user must make a detour to the target facility in this case.

In particular, as for a large store which is provided with various equipment in the store, it is necessary for the convenience of users to give route guidance considering the equipment in the store and the congestion in a parking lot.

The present invention is implemented to solve the foregoing problem. Therefore it is an object of the present invention to provide a navigation system capable of guiding a user by providing an appropriate route to a target facility, considering equipment to be used on the way to the target facility in the facilities.

A navigation system in accordance with the present invention comprises a storage unit for storing floor map information that shows a layout of gateways of a facility and placement of equipment in the facility except for lighting apparatus or sir-conditioning equipment, and for storing use pattern information that records equipment to be used in the facility; a route search unit for searching for, when a destination is set in the facility, a shortest route from a gateway of the facility to the destination among routes leading to the destination via the equipment recorded in the use pattern information in accordance with the floor map information and the use pattern information; and a route guidance unit for guiding along the route searched by the route search unit, wherein the route search unit searches for, when the destination is set in the facility, the shortest route from the gateway of the facility to the destination among the routes leading to the destination via the equipment recorded in the use pattern information, and specifies parking lot gates in ascending order of distance to the gateway of the facility connected to the route searched; and the route guidance unit guides along the route, which is searched by the route search unit, from a parking lot nearest to the gateway of the facility connected to the route searched by the route search unit.

According to the present invention, since it searches for the shortest route from the gateway of the facilities to the destination among the routes leading to the destination via the equipment recorded in the use pattern information, and guides a user along the route, it offers an advantage of being able to present the appropriate route and to guide the user to the target facility considering the equipment to be used on the way to the target facility in the facilities.

### BRIEF DESCRIPTION OF THE DRAWINGS

FIG. 1 is a diagram showing a navigation system of an embodiment 1 in accordance with the present invention and its peripheral configuration;

FIG. 2 is a block diagram showing the navigation system of the embodiment 1;

FIG. 3 is a flowchart showing a flow of the operation of the navigation system of the embodiment 1;

FIG. 4 is a flowchart showing a flow of the operation of the data reception processing unit;

FIG. 5 is a flowchart showing a flow of the operation of the received data information update processing unit;

FIG. 6 is a diagram showing an example of a floor map table;

FIG. 7 is a diagram showing an example of a parking lot gate congestion table;

FIG. 8 is a table showing a list of congestion level definition;

FIG. 9 is a diagram showing an example of a parking lot gate congestion display;

FIG. 10 is a diagram showing an example of an in-store equipment use pattern table;

FIG. 11 is a diagram showing an example of a screen for selecting an in-store equipment use pattern;

FIG. 12 is a diagram showing an example of a screen for selecting a registered in-store equipment use pattern;

FIG. 13 is a diagram showing an example of a registering screen of an in-store equipment use pattern;

FIG. 14 is a flowchart showing a flow of the operation of a parking lot gate detection processing unit;

FIG. 15 is a flowchart showing a flow of the operation of a parking place information processing unit; and

FIG. 16 is a diagram showing an example of a route guidance screen to an in-store target facility, considering the congestion state of a parking lot and in-store equipment a user wants to use.

### EMBODIMENTS FOR CARRYING OUT THE INVENTION

The best mode for carrying out the invention will now be described with reference to the accompanying drawings to explain the present invention in more detail.

### Embodiment 1

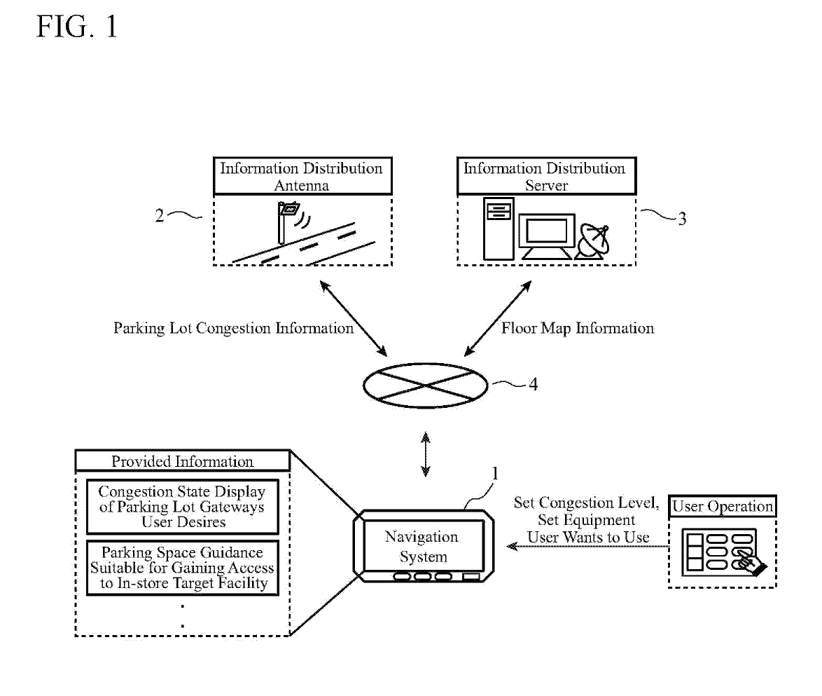

FIG. 1 is a diagram showing a navigation system of an embodiment 1 in accordance with the present invention and its peripheral configuration. In FIG. 1, a navigation system 1 in the embodiment 1 comprises a road side radio communication unit with an information distribution antenna 2 and an information distribution server 3 as a system configuration necessary for presenting a route leading from a parking lot gate to a target facility in the facilities such as a store (referred to as an in-store target facility from now on) via equipment in the facilities such as a store except for lighting apparatus or air-conditioning equipment (referred to as in-store equipment from now on).

The road side radio communication unit comprises the information distribution antenna 2 for carrying out short range radio communication such as DSRC (Dedicated Short Range Communication), and the information distribution antenna 2 is installed on a road around a parking lot gate of a facility such as a store. The onboard equipment of a vehicle entering the communication area of the information distribution antenna 2 receives information about surrounding roads and facilities distributed from the road side radio communication unit.

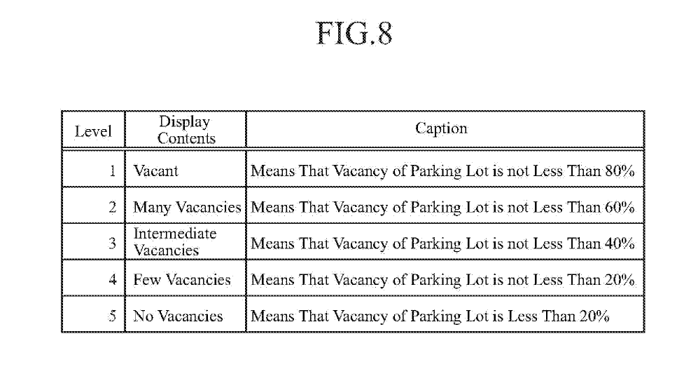

In addition, the road side radio communication unit counts the number of vehicles entering through each parking lot gate every time it communicates with the onboard equipment, and retains it as parking lot congestion information indicating the congestion state of the parking lot gates in terms of a congestion level which will be described later with reference to FIG. 8. Incidentally, the parking lot congestion information can be uploaded from the road side radio communication unit to a server system connected to a network 4 such as the Internet or a radio communication network.

The information distribution server 3, which is a server system connected to the network 4, manages a facility in facilities such as a store (referred to as an in-store facility from now on) and floor map information showing placement of the in-store equipment. In addition, the information distribution server 3 provides a version corresponding to the contents of the floor map information and manages the floor map information. For example, if the placement of the in-store facility and in-store equipment is not changed, the same version is given.

Although not shown in FIG. 1, the navigation system 1 comprises a positioning unit for acquiring vehicle's position, a map information acquiring unit for acquiring map information from a map database, and a processing unit for executing navigation processing of the vehicle, and as a characteristic operation of the embodiment 1, it retrieves, when a route whose destination is an in-store facility is set, the parking lot congestion information and floor map information about the store via the Internet using information for identifying the facility such as the store (its address, for example) as a search key.

In addition, on the navigation system 1, a user can set an acceptable congestion level and in-store equipment the user wants to use, and according to the set information and according to the parking lot congestion information and floor map information acquired via the Internet, it shows a route to the in-store target facility, which will enable the user to get smooth and shortest access thereto.

Incidentally, on the navigation system 1, a user can set any congestion level he or she desires, and it can display the congestion state of the gates of the parking lot the user wants to use, and display guidance to a parking space suitable for gaining access to the in-store target facility.

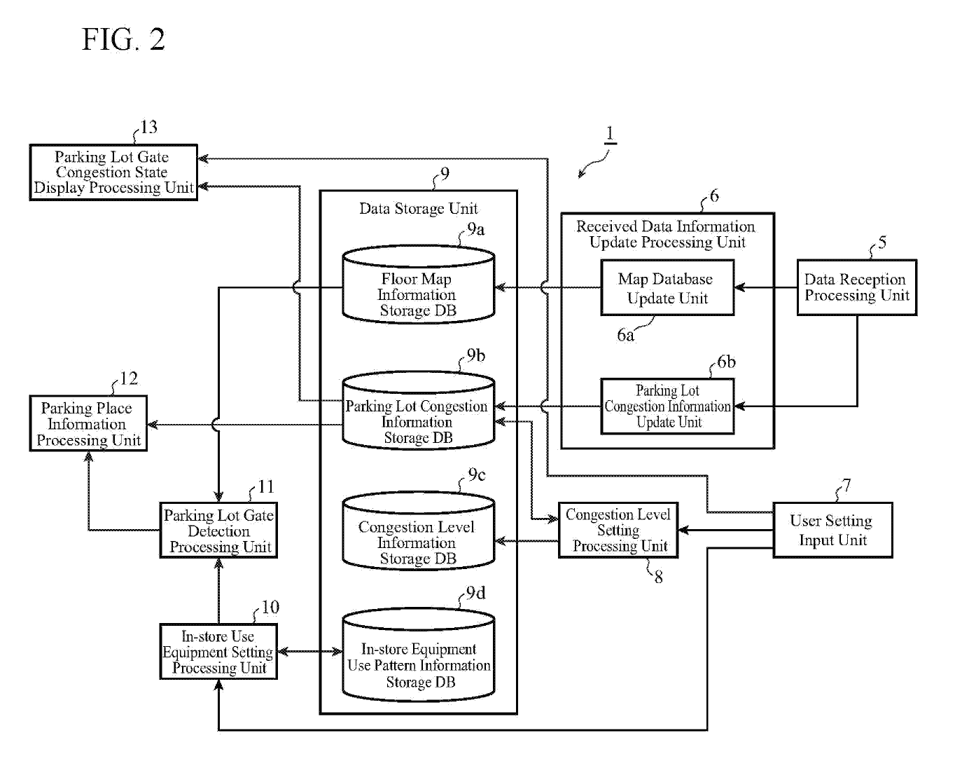

FIG. 2 is a block diagram showing the navigation system of the embodiment 1. In FIG. 2, the navigation system 1 comprises a data reception processing unit (reception processing unit) 5, a received data information update processing unit (update processing unit) 6, a user setting input unit (input unit) 7, a congestion level setting processing unit 8, a data storage unit (storage unit) 9, an in-store use equipment setting processing unit (use pattern information setting unit) 10, a parking lot gate detection processing unit (route search unit) 11, a parking place information processing unit (route guidance unit) 12 and a parking lot gate congestion state display processing unit (congestion state display processing unit) 13.

The data reception processing unit 5 is a component for receiving the floor map information and parking lot congestion information about a store near the road the vehicle is traveling and about a store in which an in-store target facility is set via the Internet.

The received data information update processing unit 6, which is a component for updating contents of a floor map information storage database (DB) 9a and contents of a parking lot congestion information storage database 9b in the data storage unit 9 using the floor map information and parking lot congestion information the data reception processing unit 5 acquires, comprises a map database update unit 6a and a parking lot congestion information update unit 6b.

The map database update unit 6a updates the contents of a floor map information storage DB 9a using the floor map information acquired from the data reception processing unit 5, and the parking lot congestion information update unit 6b updates the contents of a parking lot congestion information storage DB 9b using the parking lot congestion information data acquired from the reception processing unit 5.

The user setting input unit 7, which is a component for a user to input setting information, provides an HMI (Human Machine Interface) for setting the congestion level for the parking lot gates and in-store equipment the user wants to use with hard keys or a touch screen in accordance with a setting screen displayed on the screen of a display device (not shown in FIG. 2). The congestion level setting processing unit 8 is a component for updating the contents of a congestion level information storage DB 9c in the data storage unit 9 according to the congestion level set by the user.

The data storage unit 9, which is a storage unit for storing a database for recording the congestion state of parking lot gates, locations of in-store equipment the user wants to use on the way to an in-store target facility, and data for deciding positional relationships between gateways of the parking lot and store, comprises the floor map information storage DB 9a, parking lot congestion information storage DB 9b, congestion level information storage DB 9c and an in-store equipment use pattern information storage DB 9d.

The floor map information storage DB 9a is a database for recording in-store floor map information. The parking lot congestion information storage DB 9b is a database for recording parking lot congestion information that defines the congestion state of parking lot gates in terms of a congestion level. The congestion level information storage DB 9c is a database for recording the congestion level a user sets. The in-store equipment use pattern information storage DB 9d is a database for recording a use pattern (use pattern information) of the in-store equipment the user wants to use. For example, it retains the in-store equipment the user wants to use such as using a baby buggy in a baby buggy parking place in the store, followed by using an elevator.

The in-store use equipment setting processing unit 10 is a component for reading the in-store equipment use pattern information out of the in-store equipment use pattern information storage DB 9d, and for updating the contents of the in-store equipment use pattern information storage DB 9d in accordance with information indicating the in-store equipment use pattern that is set through the user setting input unit 7.

The parking lot gate detection processing unit (route search unit) 11 is a component for searching for the shortest route from a store gate (gateway of the store) to the in-store target facility among routes to the in-store target facility via the equipment recorded in the in-store equipment use pattern by using the floor map information and in-store equipment use pattern of the target store of the route guidance, for specifying the store gate on the shortest route as the optimum store gate, and for detecting a parking lot gate accessible to the store gate specified.

In addition, the parking place information processing unit (route guidance unit) 12 is a component for guiding the user along the optimum route leading from the parking lot to the in-store target facility via the store gate by extracting a designated parking lot gate from the parking lot gates detected by the parking lot gate detection processing unit 11 according to the congestion state of the parking lot gates and according to the congestion level the user sets, and by specifying from the parking lots accessible from the parking lot gate the parking lot nearest to the store gate connected to the route leading to the in-store target facility via the in-store equipment the user wants to use. The parking lot gate congestion state display processing unit 13 is a component for displaying on the display device the congestion levels of the parking lot gates readout of the parking lot congestion information storage DB 9b of the data storage unit 9 as the congestion state information.

Next the operation will be described.

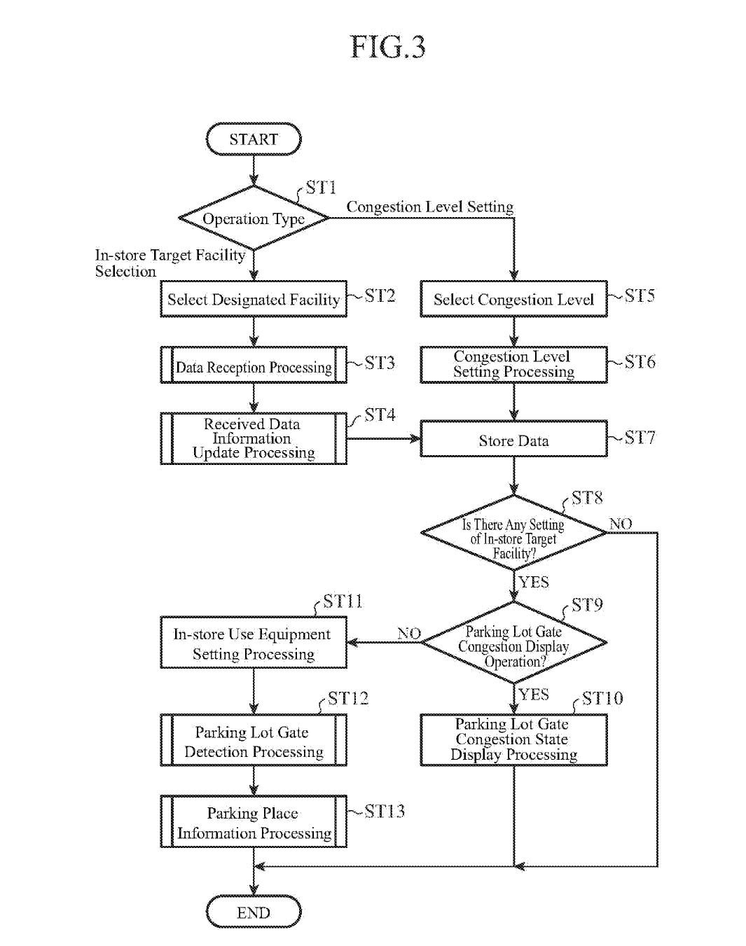

FIG. 3 is a flowchart showing a flow of the operation of the navigation system of the embodiment 1. Referring to FIG. 3, details of the setting processing of a route whose destination is an in-store facility will be described.

First, the user setting input unit 7 of the navigation system 1 causes the display device to display a screen for a user to select in-store target facility selection processing for selecting an in-store facility as a destination or to select congestion level setting processing for registering a congestion level the user sets, and accepts the selection by the user operation (step ST1). Here, assuming that the in-store target facility selection processing is selected by the user operation and that the store which will be provided with the route guidance and the in-store facility which is the destination of the route are selected (step ST2), the user setting input unit 7 notifies the data reception processing unit 5 of the store and facility. This causes the data reception processing unit 5 to proceed to the reception processing of the floor map information about the store.

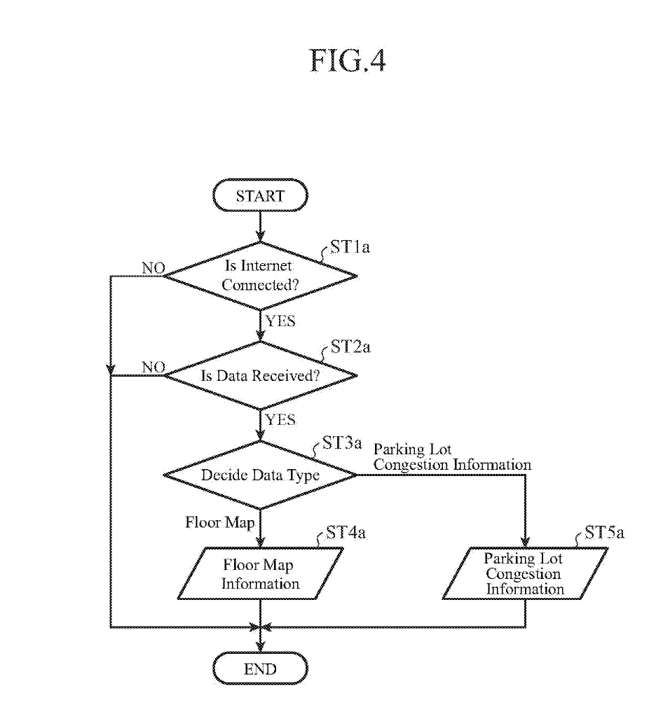

FIG. 4 is a flowchart showing a flow of the operation of the data reception processing unit 5, which corresponds to the processing at step ST3 of FIG. 3.

First, receiving the notification, the data reception processing unit 5 decides on whether there is a connection with the Internet or not (step ST1a). Here, unless there is a connection with the Internet (NO at step ST1a), the data reception processing unit 5 terminates the processing.

On the other hand, if the Internet is connectable (YES at step ST1a), the data reception processing unit 5 inquires of the road side radio communication unit with the information distribution antenna 2 installed on the parking lot gate in the store (or the server system to which the information indicating the congestion state is uploaded from the road side radio communication unit) and of the information distribution server 3 about the presence or absence of the received data (step ST2a). Incidentally, as for the received data mentioned above, it is, for the road side radio communication unit or server system, the parking lot congestion information indicating the congestion state at the parking lot gates such as the number of vehicles passing through the communication area of the information distribution antenna 2, and for the information distribution server 3, the floor map information showing the placement of the in-store facilities and in-store equipment.

Unless the received data is present (NO at step ST2a), the data reception processing unit 5 terminates the processing. In contrast, if the received data is present (YES at step ST2a), the data reception processing unit 5 downloads the data (including version information) from the road side radio communication unit (or server system) and from the information distribution server 3, and decides a data type (step ST3a). Subsequently, the data reception processing unit 5 decides the floor map information on the store to be provided with the route guidance from the downloaded data, followed by supplying the floor map information to the map database update unit 6a of the received data information update processing unit 6 (step ST4a). On the other hand, when the data reception processing unit 5 detects the parking lot congestion information indicating the congestion states of the parking lots of the store to be provided with the route guidance from the downloaded data, it supplies the parking lot congestion information to the parking lot congestion information update unit 6b of the received data information update processing unit 6 (step ST5a).

Returning to the description of FIG. 3, if the data reception processing is completed at step ST3, the received data information update processing unit 6 executes the received data information update processing (step ST4).

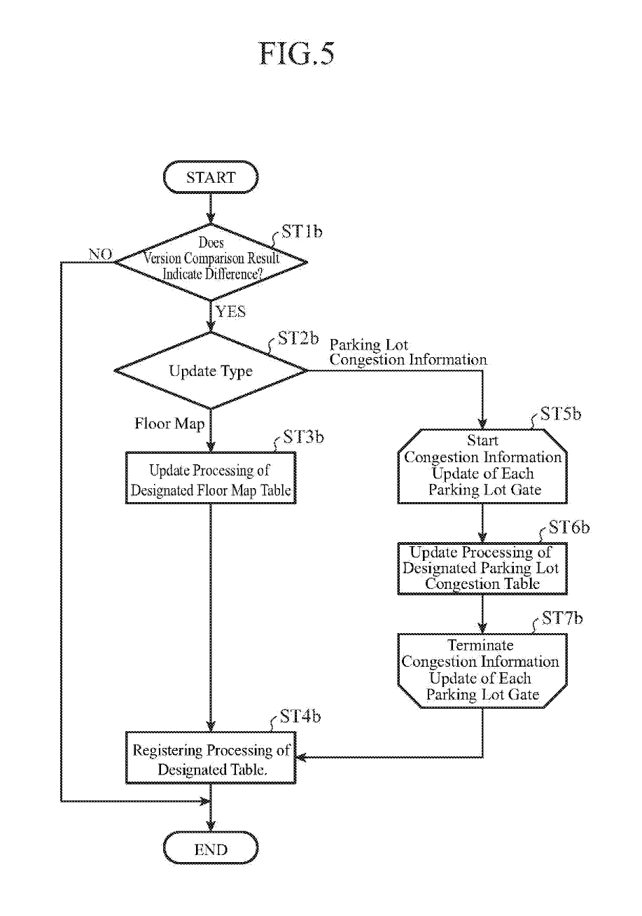

FIG. 5 is a flowchart showing a flow of the operation of the received data information update processing unit 6, which corresponds to the processing at step ST4 of FIG. 3. The map database update unit 6a compares the version information on the data supplied from the data reception processing unit 5 with the version information on the existing data stored in the database 9a, and decides on whether it is necessary to update the database or not (step ST1b). If the type of the data to be updated is the floor map information (floor map at step ST2b), the map database update unit 6a updates the contents of the floor map information storage DB 9a in the data storage unit 9 using the data supplied from the data reception processing unit 5 (step ST3b). Incidentally, the floor map information storage DB 9a records the floor map information on each facility such as a store as table data (referred to as a “floor map table” from now on).

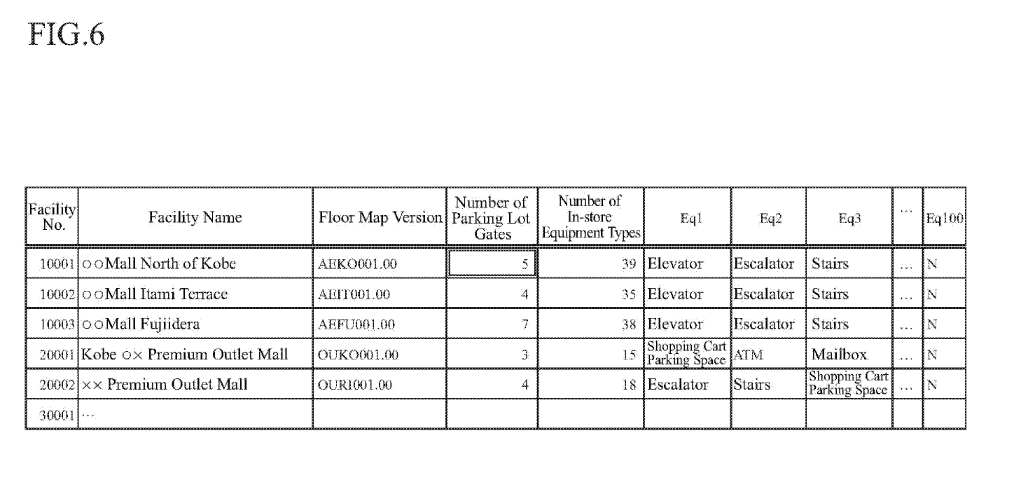

FIG. 6 is a diagram showing an example of the floor map table. As shown in FIG. 6, the floor map information on individual facilities consists of a “facility No.” for specifying the floor map information on each facility, a “facility name”, a “floor map version”, the “number of parking lot gates” indicating the number of the parking lot gates of each facility, the “number of in-store equipment types” indicating the number of various pieces of the in-facility equipment, and the floor map information record in which the equipment names and their identification numbers Eq1, Eq2, Eq3, . . . are set.

The map database update unit 6a retrieves the floor map information record to be updated from the floor map table using the “facility No.”, and executes, if the floor map version of the floor map information record differs from that of the input data, the update processing of the floor map information record. Incidentally, if the floor map information record to be updated is not present, a new “facility No.” is given to add the floor map information record. After updating the contents of the floor map information record as described above, the map database update unit 6a stores the updated record in the floor map table (step ST4b).

On the other hand, when the type of the data to be updated is the parking lot congestion information (parking lot congestion information at step ST2b), the parking lot congestion information update unit 6b identifies the parking lot congestion information for each corresponding parking lot gate in the parking lot congestion information storage DB 9b, and starts updating using the data supplied from the data reception processing unit 5 (step ST5b). Incidentally, the parking lot congestion information storage DB 9b records the parking lot congestion information for each parking lot gate as table data (referred to as a “parking lot gate congestion table” from now on).

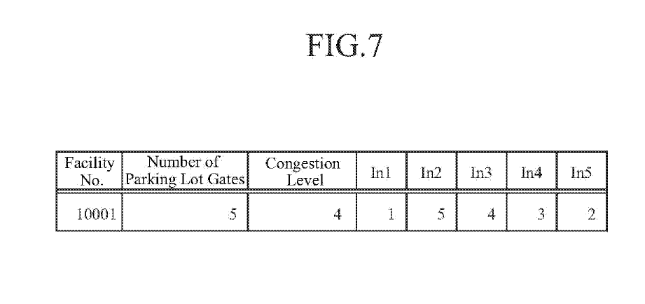

FIG. 7 is a diagram showing an example of the parking lot gate congestion table. As shown in FIG. 7, the parking lot congestion information on each parking lot gate of each facility consists of a “facility No.” for identifying the floor map information on each facility, the “number of parking lot gates” indicating the number of the parking lot gates of the facility, a “congestion level” for setting the congestion level the user accepts, identification numbers In1-In5 of the parking lot gates and the parking lot congestion information record in which their congestion levels are set. Incidentally, in the foregoing “congestion level”, the congestion level the user selects is set as will be described later.

The parking lot congestion information update unit 6b retrieves the parking lot congestion information record to be updated from the parking lot gate congestion table using the “facility No.”, and executes the update processing of the parking lot gate congestion record for each parking lot gate (step ST6b). Incidentally, if the parking lot congestion information record to be updated is not present, a new “facility No.” is given to add a parking lot congestion information record. When the update processing for each parking lot gate is completed (step ST7b), the parking lot congestion information update unit 6b proceeds to step ST4b to records the updated record in the parking lot gate congestion table. Incidentally, step ST4b corresponds to step ST7 of FIG. 3.

In FIG. 3, if the congestion level setting is selected at step ST1, the user setting input unit 7 displays a screen for selecting the congestion level on the display device to prompt the user to select an acceptable congestion level. FIG. 8 is a table showing a list of congestion level definition. Referring to the congestion level definition as shown in FIG. 8 and the screen for selecting it, the user selects a congestion level using the user setting input unit 7 (step ST5). Information indicating the selected congestion level is supplied from the user setting input unit 7 to the congestion level setting processing unit 8.

The congestion level setting processing unit 8 stores the congestion level supplied from the user setting input unit 7 in the congestion level information storage DB 9c in the data storage unit 9, and reads the record of the corresponding facility from the parking lot gate congestion table of the parking lot congestion information storage DB 9b to set the congestion level in the “congestion level” section of the record (step ST6). After that, the congestion level setting processing unit 8 stores the parking lot congestion information record including the congestion level the user sets in the parking lot gate congestion table (step ST7).

The foregoing processing from step ST1 to step ST7 corresponds to the storage processing of the data used in setting the route whose destination is the in-store facility. Incidentally, as for the data storage processing, it is not always necessary to execute it after setting the route whose destination is the in-store facility. For example, it is also possible to set only a facility such as a store at regular intervals or at a time the user desires as preprocessing of the route setting, and to carry out the data storage after acquiring the floor map information and parking lot congestion information on the facility.

At the stage where the data storage processing is completed, the user setting input unit 7 confirms the presence or absence of the setting of an in-store target facility (step ST8). Here, whether a route leading to an in-store facility destination is set or not is decided according to whether the data storage unit 9 stores the floor map information and parking lot congestion information or not. If no in-store target facility is set (NO at step ST8), the navigation system 1 decides that a route whose destination is the in-store facility is not set and terminates the processing.

In contrast, if the in-store target facility is set (YES at step ST8), the user setting input unit 7 accepts the operation of parking lot gate congestion display (step ST9). For example, it accepts the operation for a prescribed time period from the setting of the in-store target facility, or for a prescribed time period when the vehicle approaches the store within a prescribed distance.

Here, receiving the operation that commands the parking lot gate congestion display (YES at step ST9), the user setting input unit 7 notifies the parking lot gate congestion state display processing unit 13 of that.

Receiving the notification, the parking lot gate congestion state display processing unit 13 reads from the parking lot congestion information storage DB 9b in the data storage unit 9 the parking lot congestion information record about the parking lots of the store to be provided with the route guidance. In addition, using the map data of the store read out of a map database not shown in FIG. 2, it causes the display device to display an image that visualizes the congestion state of the individual parking lots of the store (step ST10).

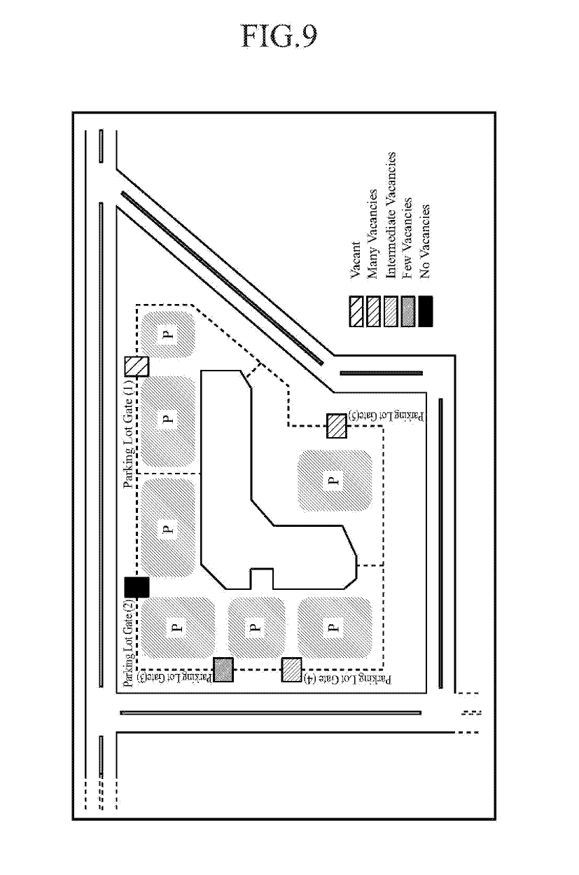

FIG. 9 is a diagram showing an example of the parking lot gate congestion display. The example of FIG. 9, which is a parking lot gate congestion display of the store corresponding to the parking lot congestion information record of FIG. 7, displays the congestion levels of five parking lot gates which are classified by color. The individual congestion levels of the parking lot gates have been acquired as the parking lot congestion information immediately before, and the user can appropriately confirm the congestion state of the individual parking lot gates visually by watching the display screen.

Incidentally, when carrying out the foregoing parking lot gate congestion display, the system makes a decision that the user requires route guidance which emphasizes only the congestion state of the parking lot gates rather than optimization of the route to the in-store target facility, and terminates the processing.

On the other hand, unless the operation commanding the parking lot gate congestion display is performed (NO at step ST9), the user setting input unit 7 notifies the in-store use equipment setting processing unit 10 of that.

Receiving the notification, the in-store use equipment setting processing unit 10 executes the setting processing of the equipment the user wants to use in the store interactively with the user (step ST11).

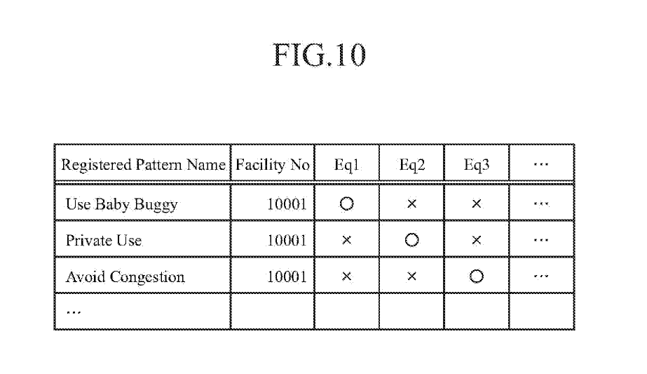

The in-store equipment use pattern information storage DB 9d records use patterns of the equipment of each registered store as table data (referred to as “in-store equipment use pattern table” from now on). FIG. 10 is a diagram showing an example of the in-store equipment use pattern table. As shown in FIG. 10, the use patterns of the in-store equipment consist of a “registered pattern name” for designating a use pattern recorded in the in-store equipment use pattern table, a “facility No.” for designating a store (facility), identification numbers Eq1, Eq2, Eq3, . . . of individual pieces of the equipment in the store and a use pattern information record in which the presence or absence of their use is set. As for the “registered pattern names”, the user can set them as desired.

First, the in-store use equipment setting processing unit 10 causes a user to select either calling a use pattern of the in-store equipment which has been registered in the in-store equipment use pattern information storage DB 9d or registering a use pattern of the equipment which is set by the user as desired.

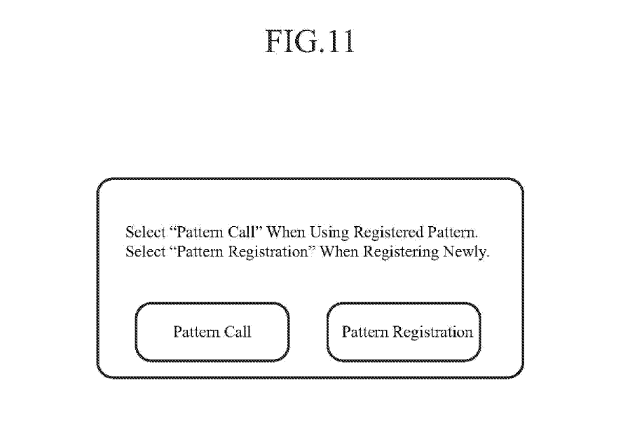

FIG. 11 is a diagram showing an example of a screen for selecting an in-store equipment use pattern. The in-store use equipment setting processing unit 10 causes the display device to display the selection screen as shown in FIG. 11, and the user executes selection by pushing a “pattern call” button or a “pattern register” button through the user setting input unit 7.

When the “pattern call” button is depressed, the user setting input unit 7 notifies the in-store use equipment setting processing unit 10 of that. Receiving the notification, the in-store use equipment setting processing unit 10 reads the use pattern information record concerning the corresponding store from the in-store equipment use pattern table of the in-store equipment use pattern information storage DB 9d, and causes the display device to display the selection screen of the registered in-store equipment use pattern.

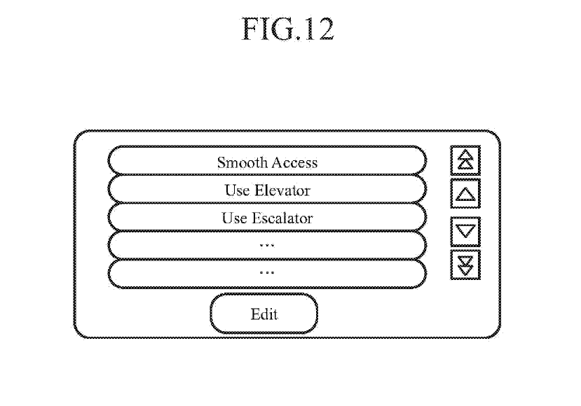

FIG. 12 is a diagram showing an example of the selection screen of the registered in-store equipment use pattern. When the “pattern call” button shown in FIG. 11 is touched, the in-store use equipment setting processing unit 10 causes the display device to display a list consisting of buttons on which the “registered pattern names” are written as shown in FIG. 10 as the screen for selecting a registered in-store equipment use pattern, thereby making the user select a desired use pattern.

On the other hand, when the “pattern register” button shown in FIG. 11 or an “editing” button shown in FIG. 12 is touched, the in-store use equipment setting processing unit 10 causes the display device to display a registering screen of an in-store equipment use pattern, and executes registering processing of the use pattern of the in-store equipment interactively with the user.

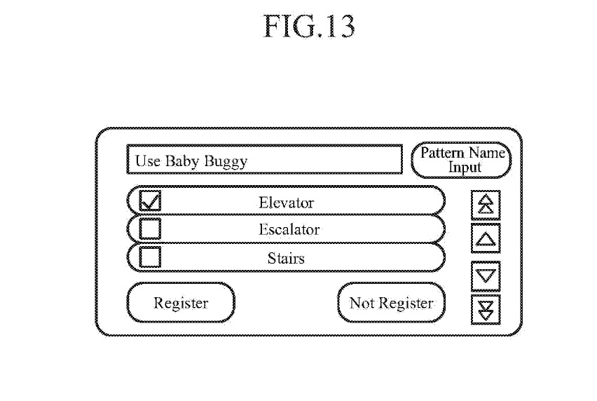

FIG. 13 is a diagram showing an example of the registering screen of the in-store equipment use pattern. The example shown in FIG. 13 displays a “pattern name input” section that can designate a registered pattern name, check boxes for selecting apiece of the equipment, and a “register” button and “not register” button indicating whether to register or not. The user checks a box of the in-store equipment the user wants to use through the user setting input unit 7, inputs a use pattern name into the “pattern name input” section and then touches the “register” button, thereby supplying the input information to the in-store use equipment setting processing unit 10. The in-store use equipment setting processing unit 10 creates a use pattern information record from the information and registers it in the in-store equipment use pattern table.

Returning to the description of FIG. 3, when the in-store use equipment setting processing is completed as described above, the parking lot gate detection processing unit 11 detects the order of parking lot gates that enable smooth access to the in-store target facility via the in-store equipment the user wants to use (step ST12).

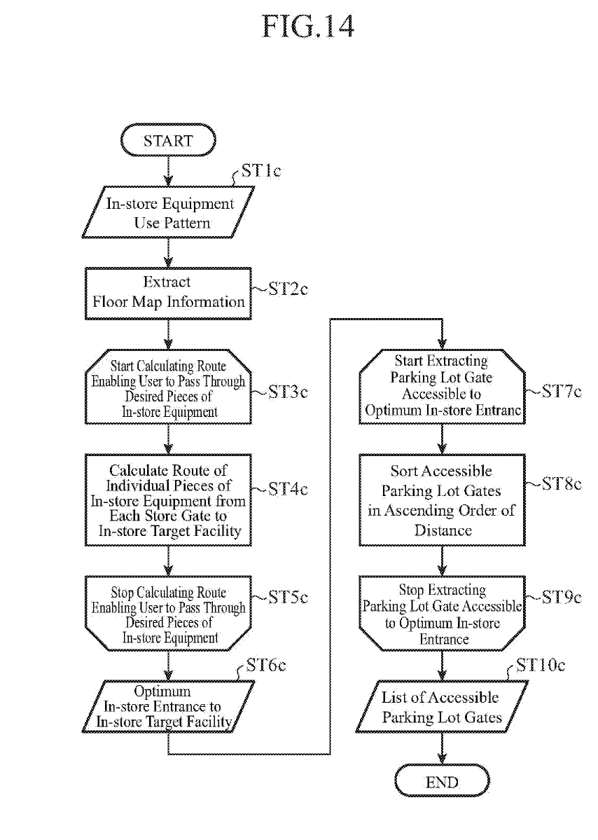

FIG. 14 is a flowchart showing a flow of the operation of the parking lot gate detection processing unit 11. First, the parking lot gate detection processing unit 11 acquires the in-store equipment use pattern concerning the store to be provided with the route guidance, which is read out of the in-store equipment use pattern table by the in-store use equipment setting processing unit 10 (step ST1c). Next, the parking lot gate detection processing unit 11 reads out the floor map information about the store to be provided with the route guidance from the floor map table of the floor map information storage DB 9a (step ST2c).

Using the in-store equipment use pattern and floor map information, the parking lot gate detection processing unit 11 calculates all the routes from the individual gates of the store to be provided with the route guidance to the in-store target facility via the in-store equipment set in the in-store equipment use pattern (step ST3c-step ST5c). Subsequently, the parking lot gate detection processing unit 11 sorts the resultant routes considering smooth accessibility to the in-store equipment and in ascending order of the distance from the gates of the store to the in-store target facility, thereby searching for the shortest route from the store gates to the in-store target facility and deciding the gate of the store on the shortest route (referred to as the “optimum store gate” from now on) (step ST6c).

From step ST7c to step ST9c, the parking lot gate detection processing unit 11 extracts all the parking lot gates accessible to the optimum store gate decided at step ST6c by using the map data on the store, and sorts the resultant parking lot gates in ascending order of distance from the parking lot gate to the optimum store gate. Finally, the parking lot gate detection processing unit 11 supplies the parking place information processing unit 12 with the information indicating the parking lot gates listed in ascending order of distance from the optimum store gate (step ST10c).

At step ST13, the parking place information processing unit 12 decides the optimum route from the parking lot gate to the in-store target facility using the list of the parking lot gates accessible to the optimum store gate obtained by the parking lot gate detection processing unit 11 and using the parking lot congestion information record about the parking lots of the store to be provided with the route guidance, which is read out of the parking lot gate congestion table of the parking lot congestion information storage DB 9b, and causes the display device to display the optimum route. Details of the processing will be described below.

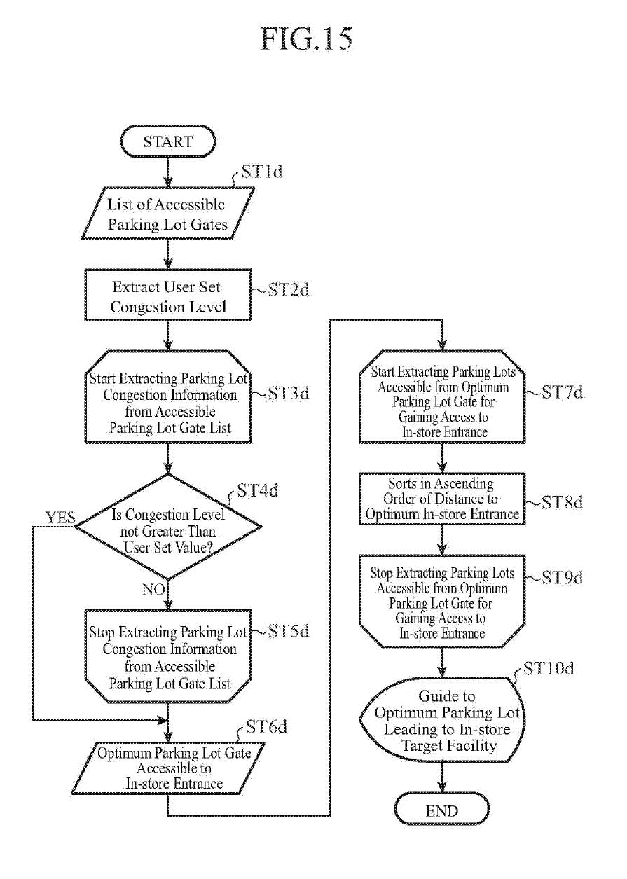

FIG. 15 is a flowchart showing a flow of the operation of the parking place information processing unit 12.

First, the parking place information processing unit 12 acquires the list of the parking lot gates that enable access to the optimum store gate decided by the parking lot gate detection processing unit 11 (step ST1d).

Next, the parking place information processing unit 12 reads the parking lot congestion information record about the parking lots of the store to be provided with the route guidance from the parking lot gate congestion table of the parking lot congestion information storage DB 9b, and extracts the congestion level the user sets from the parking lot congestion information record (step ST2d). Here, it extracts the value set in the “congestion level” section of the parking lot congestion information record shown in FIG. 7.

Subsequently, as for the individual parking lot gates listed as those accessible to the optimum store gate, the parking place information processing unit 12 extracts the congestion levels from the parking lot congestion information record, compares the resultant congestion levels with the congestion level the user sets, and extracts the parking lot gates with the levels not greater than the congestion level the user sets (step ST4d-step ST5d).

Next, using the map data about the store, the parking place information processing unit 12 extracts individual parking lots accessible from the parking lot gate specified as described above, and sorts the resultant parking lots in ascending order of distance to the optimum store gate (step ST7d-step ST9d).

Finally, as for the parking lots sorted in ascending order of distance to the optimum store gate, the parking place information processing unit 12 decides the route with the shortest distance from the parking lot to the in-store target facility as the optimum route and guides the user by displaying the route on the display device (step ST10d).

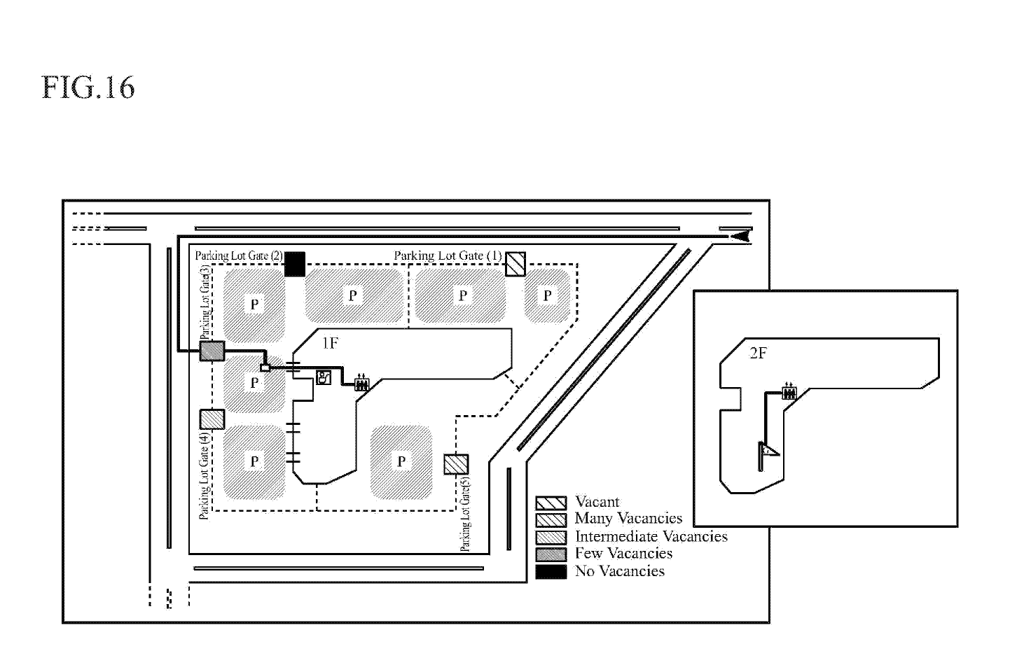

FIG. 16 is a diagram showing an example of a route guidance screen to the in-store target facility considering the congestion state of the parking lot and access to the in-store equipment the user wants to use. FIG. 16 shows an example in which the user sets “4” as the congestion level of the parking lots, sets the “baby buggy parking place” and “elevator” in the use pattern of the in-store equipment as the in-store equipment the user wants to use, and sets a facility on the second floor as the in-store target facility.

If it decides the parking lot gate considering only the congestion level the user sets, it will extract the parking lot gates (1) and (3)-(5) as the parking lot gates with levels not greater than the congestion level. However, when it considers the in-store equipment the user desires to use, it decides the parking lot gate (3) of the parking lots accessible to the store gate on the shortest route (optimum store gate) leading to the in-store target facility via the in-store equipment set in the use pattern. This will cause the display device to display the route leading to the in-store target facility from the parking lot gate (3) via the optimum store gate, baby buggy parking place and elevator as shown in FIG. 16. Following the guidance, the user can reach the desired in-store target facility after parking the vehicle in the parking lot nearest to the optimum store gate, walking through the optimum store gate, using the baby buggy at the baby buggy parking place, and going up to the second floor in the elevator.

Incidentally, although FIG. 16 shows the example of guiding the user by displaying on the display device the route that leads from the parking lot gate (3) to the in-store target facility via the optimum store gate, baby buggy parking place and elevator, the parking place information processing unit 12 can also provide the user with audio guidance with reference to the individual locations of the parking lot gate (3), optimum store gate, baby buggy parking place and elevator.

As described above, according to the present embodiment 1, it comprises the data storage unit 9 for storing the floor map information that indicates gateways of a facility and placement of in-facility equipment, and the use patterns in which equipment to be used in the facility is registered; the parking lot gate detection processing unit 11 for searching for, when a destination is set in the facility, the shortest route from the gateway of the facility to the destination among the routes leading to the destination via the equipment recorded in the use pattern according to the floor map information and use pattern; and the parking place information processing unit 12 for guiding the user along the route searched by the parking lot gate detection processing unit 11. The configuration can guide the user by presenting the appropriate route to the target facility considering the equipment to be used on the way to the target facility in the facilities.

In addition, according to the present embodiment 1, since it comprises the data reception processing unit 5 for acquiring floor map information through communication with the outside, and the received data information update processing unit 6 for updating the contents of the data storage unit 9 using the floor map information acquired by the data reception processing unit 5, it can update the floor map information in accordance with the new floor map even if the floor map of the facility has been altered.

Furthermore, according to the present embodiment 1, since it comprises the user setting input unit 7 for accepting information input from the outside, and the in-store use equipment setting processing unit 10 for generating the use pattern that records the equipment input from the user setting input unit 7 and for storing the use pattern in the data storage unit 9, it can register the in-store equipment the user wants to use in the use pattern.

Furthermore, according to the present embodiment 1, the data storage unit 9 further stores the parking lot congestion information indicating the congestion level of the parking lot gate of the facility and the congestion level the user sets; the parking lot gate detection processing unit 11 searches for, when the destination is set in the facility, the shortest route from the gateway of the facility to the destination among the routes leading to the destination via the equipment registered in the use pattern, and decides the parking lot gates in ascending order of distance to the gateway (optimum store gate) of the facility connected to the route searched; and the parking place information processing unit 12 extracts the parking lot gates that satisfy the congestion level the user sets from among the parking lot gates decided by the parking lot gate detection processing unit 11 in accordance with the parking lot congestion information and the congestion level the user sets, and guides the user along the route from the parking lot nearest to the optimum store gate, which is searched by the parking lot gate detection processing unit 11 among the parking lots accessible from the extracted parking lot gate.

The configuration with the foregoing arrangement can present an appropriate route to the in-store target facility considering the congestion state of the parking lot and the equipment used on the way to the target facility in the facilities, and guide the user along the route.

Furthermore, according to the present embodiment 1, since it comprises the data reception processing unit 5 for acquiring the parking lot congestion information from the road side radio communication unit that measures the congestion states of the parking lot gates and generates the parking lot congestion information, and the received data information update processing unit 6 for updating the contents of the data storage unit 9 by using the parking lot congestion information the data reception processing unit 5 acquires, it can acquire the congestion state in real time.

Furthermore, according to the present embodiment 1, since it comprises the parking lot gate congestion state display processing unit 13 for classifying and displaying the congestion states of the parking lot gates by color in accordance with the parking lot congestion information, the user can visually confirm the congestion states of the parking lot gates with ease.

Incidentally, in the foregoing embodiment 1, a configuration is also possible which stores positional information about a specific gateway other than a common vehicle gateway such as an emergency vehicle entrance in the floor map information storage DB 9a as the floor map information, and gives a warning to the user by voice or image display by controlling a warning device not shown in FIG. 2 if the parking place information processing unit 12 decides that the vehicle enters the specific gateway according to the vehicle position and the position information about the specific gateway regardless of the presence or absence of the route.

### INDUSTRIAL APPLICABILITY

A navigation system in accordance with the present invention is suitable for a car navigation system mounted in a vehicle because it can present an appropriate route from a parking lot to an internal facility such as a store by considering the position of the equipment to be used on the way to a target facility in the store and positional relationships between the gateways of the parking lot and of the store, and can guide the user along the route.

1.-7. (canceled)

8. A navigation system comprising:
a storage unit for storing floor map information that shows a layout of gateways of a facility and placement of equipment in the facility except for lighting apparatus or air-conditioning equipment, and for storing use pattern information that records equipment to be used in the facility;
a route search unit for searching for, when a destination is set in the facility, a shortest route from a gateway of the facility to the destination among routes leading to the destination via the equipment recorded in the use pattern infounation in accordance with the floor map information and the use pattern information; and
a route guidance unit for guiding along the route searched by the route search unit, wherein
the route search unit searches for, when the destination is set in the facility, the shortest route from the gateway of the facility to the destination among the routes leading to the destination via the equipment recorded in the use pattern information, and specifies parking lot gates in ascending order of distance to the gateway of the facility connected to the route searched; and
the route guidance unit guides along the route, which is searched by the route search unit, from a parking lot nearest to the gateway of the facility connected to the route searched by the route search unit.

9. The navigation system according to claim 8, wherein
the storage unit further stores parking lot congestion information indicating congestion levels of the parking lot gates of the facility and a congestion level a user sets; and
the route guidance unit extracts, according to the parking lot congestion information and the congestion level the user sets, parking lot gates which satisfy the congestion level the user sets from the parking lot gates specified by the route search unit, and guides along the route, which is searched by the route search unit, from the parking lot gate nearest to the gateway of the facility connected to the route searched by the route search unit among the parking lots accessible from the parking lot gates extracted.

10. The navigation system according to claim 8, further comprising:
a reception processing unit for acquiring the floor map information through communication with outside; and
an update processing unit for updating contents of the storage unit using the floor map information acquired by the reception processing unit.

11. The navigation system according to claim 8, further comprising:
an input unit for accepting information input from outside; and
a use pattern information setting unit for generating use pattern information that records equipment input through the input unit, and for storing the use pattern information in the storage unit.

12. The navigation system according to claim 9, further comprising:
a reception processing unit for acquiring the parking lot congestion information from a communication unit that measures congestion states of the parking lot gates and generates the parking lot congestion information; and
an update processing unit for updating contents of the storage unit by using the parking lot congestion information acquired by the reception processing unit.

13. The navigation system according to claim 9, further comprising:
a congestion state display processing unit for classifying and displaying the congestion states of the parking lot gates by color in accordance with the parking lot congestion information.

14. The navigation system according to claim 8, wherein
the route guidance unit gives a warning to a user if the route guidance unit makes a decision that a vehicle of the user enters a specific gateway of the facility in accordance with the floor map information and the position of the vehicle.
